(19) United States
(12) Patent Application Publication
(10) Pub. No.: US 2018/0272499 A1
(43) Pub. Date: Sep. 27, 2018

(54) Centric clamping vise

(71) Applicant: Chin-Tsun Cheng, Taichung (TW)

(72) Inventor: Chin-Tsun Cheng, Taichung (TW)

(21) Appl. No.: 15/989,209

(22) Filed: May 25, 2018

(51) Int. Cl. B25B 1/10; B25B 1/02

(52) U.S. Cl. CPC B25B 1/103; B25B 1/02

(57) ABSTRACT

A centric clamping vise includes a base support including a longitudinal groove and two longitudinal tunnels at two sides of the groove respectively; a threaded spindle including an intermediate, ring-shaped enlargement, a right-handed-threaded section between the enlargement and a first end, and a left-handed-threaded section between the enlargement and a second end; a first jaw moveably disposed on a first end of the groove and including a threaded channel with the right-handed-threaded section disposed through; a second jaw moveably disposed on a second end of the groove and including a threaded channel with the left-handed-threaded section disposed through; an upper positioning member including two side shoulders, two threaded holes and a half-circular bottom cavity; a lower positioning member including two threaded holes and a half-circular top cavity; and two set screws each driven through the threaded holes to join the upper and lower positioning members.

### BACKGROUND OF THE INVENTION

### 1. Field of the Invention

The invention relates to vises and more particularly to a centric clamping vise capable of being threadedly adjusted in response to misalignment.

### 2. Description of Related Art

A conventional centric clamping vise comprises a base support having a longitudinal axis, on which a first jaw mount, guided by a first carriage, and a second jaw mount, guided by a second carriage, are adjustably supported along an adjustment path oriented parallel to the longitudinal axis with the aid of a spindle drive. A pair of first slides is assigned to the first carriage, and a pair of second slides is assigned to the second carriage. The difference between the track width of the first slides and the track width of second slides is greater than the width of second slides

While the device enjoys its success in the market, continuing improvements in the exploitation of centric clamping vise are constantly being sought.

### SUMMARY OF THE INVENTION

It is therefore one object of the invention to provide a centric clamping vise, comprising a base support including a longitudinal groove and two longitudinal tunnels at two sides of the longitudinal groove respectively; a threaded spindle including an intermediate, ring-shaped enlargement, a right-handed-threaded section between the intermediate, ring-shaped enlargement and a first end, and a left-handed-threaded section between the intermediate, ring-shaped enlargement and a second end; a first jaw moveably disposed on a first end of the longitudinal groove and including a longitudinal threaded channel with the right-handed-threaded section threadedly disposed through to expose the first end of the threaded spindle; a second jaw moveably disposed on a second end of the longitudinal groove and including a longitudinal threaded channel with the left-handed-threaded section threadedly disposed through to expose the second end of the threaded spindle; an upper positioning member including two shoulders at two sides respectively, two threaded holes each adjacent to the shoulder, and a half-circular cavity on a bottom; a lower positioning member including two threaded holes adjacent to two sides respectively, and a half-circular cavity on a top; and two set screws each driven through the threaded hole of the upper positioning member into the threaded hole of the lower positioning member to join the upper positioning member and the lower positioning member; wherein the intermediate, ring-shaped enlargement is complimentarily disposed between the half-circular cavity of the upper positioning member and the half-circular cavity of the lower positioning member; wherein the lower positioning member is disposed on a lower portion of the longitudinal groove; and wherein the upper positioning member is disposed on an upper portion of the longitudinal groove with the shoulders slidably disposed in the tunnels respectively.

The above and other objects, features and advantages of the invention will become apparent from the following detailed description taken with the accompanying drawings.

### BRIEF DESCRIPTION OF THE DRAWINGS

FIG. 1 is a perspective view of a centric clamping vise according to the invention;

FIG. 2 is an exploded view of the centric clamping vise;

FIG. 3 is another view of FIG. 2;

FIG. 4 is a schematic end view in part section of the centric clamping vise showing an unfastening of the upper positioning member and the lower positioning member prior to adjustment; and

FIG. 5 is a view similar to FIG. 4 showing the upper positioning member and the lower positioning member after the adjustment.

### DETAILED DESCRIPTION OF THE INVENTION

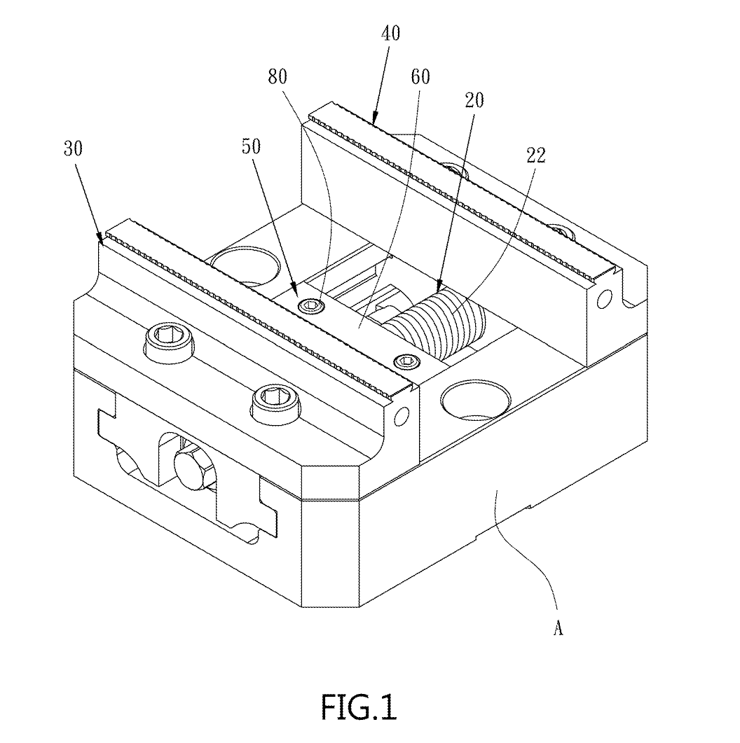

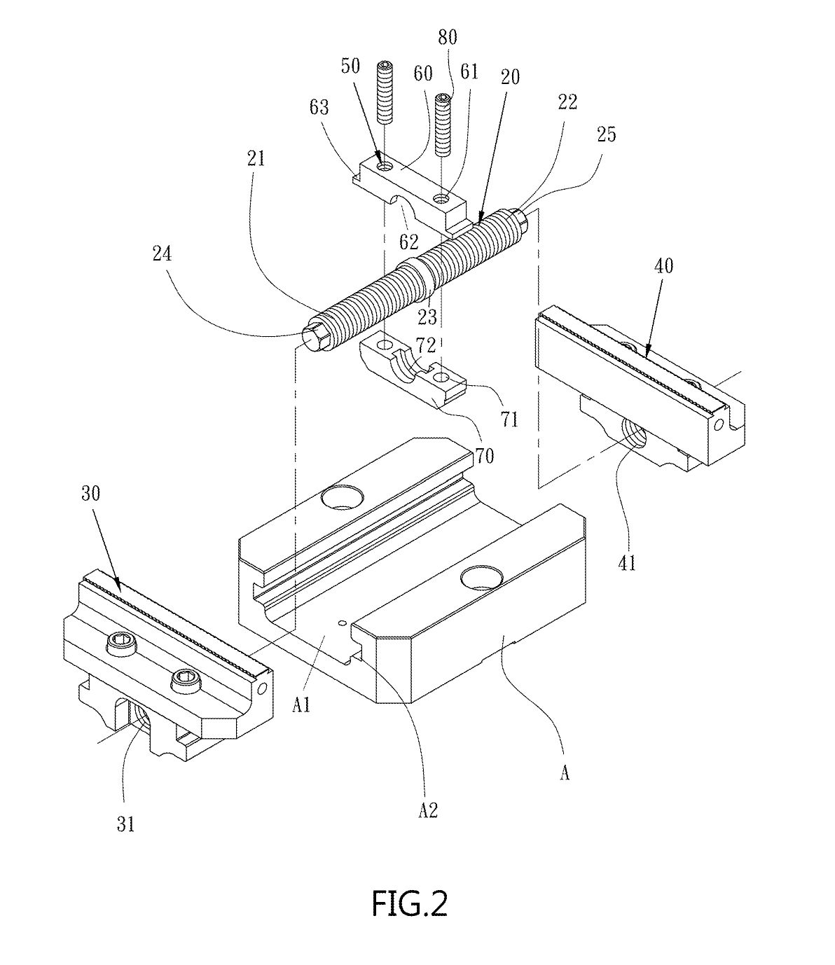

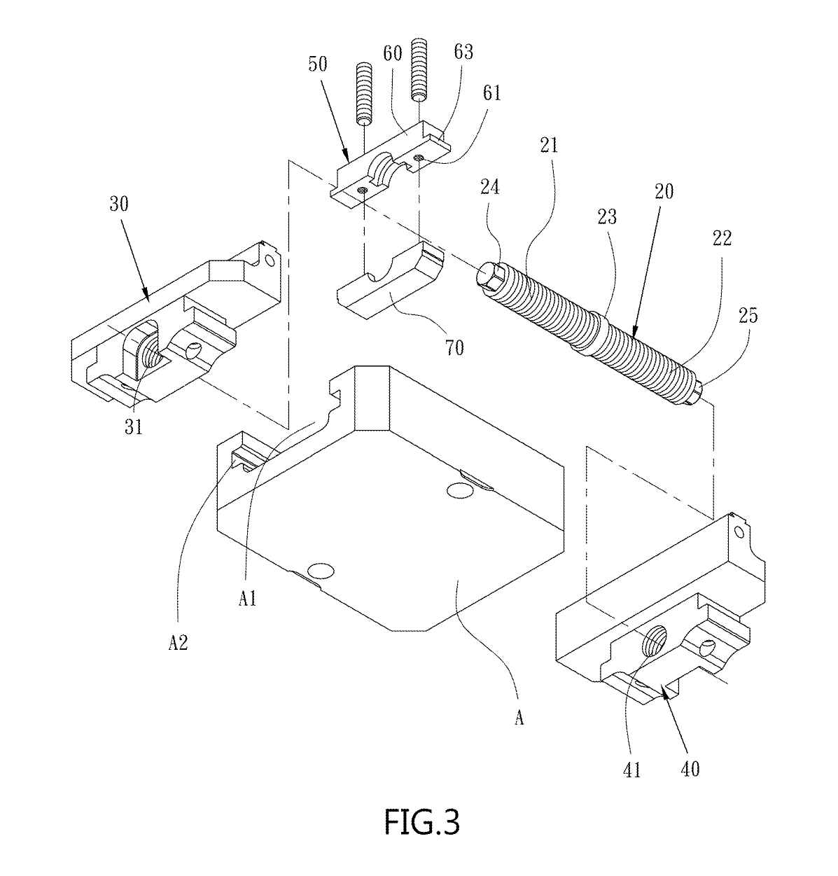

Referring to FIGS. 1 to 5, a centric clamping vise in accordance with the invention comprises the following components as discussed in detail below.

A base support A includes a longitudinal, central groove A1 and two longitudinal tunnels A2 at two sides of the groove A1 respectively.

A threaded spindle 20 includes a hexagonal first end 24, a hexagonal second end 25, an intermediate, ring-shaped enlargement 23, a right-handed-threaded section 21 between the enlargement 23 and the first end 24, and a left-handed-threaded section 22 between the enlargement 23 and the second end 25.

A first jaw 30 is disposed on a first end of the groove A1 and includes a longitudinal threaded channel 31 with the right-handed-threaded section 21 threadedly disposed through. Thus, the first jaw 30 may slide with respect to the base support A. Likewise, a second jaw 40 is disposed on a second end of the groove Al and includes a longitudinal threaded channel 41 with the left-handed-threaded section 22 threadedly disposed through. Thus, the second jaw 40 may slide with respect to the base support A. The first end 24 is exposed at the mouth of the threaded channel 31 and the second end 25 is exposed at the mouth of the threaded channel 41.

A positioning assembly 50 comprises an upper positioning member 60 including two shoulders 63 at two sides respectively, two threaded holes 61 each adjacent to the shoulder 63, and a half-circular cavity 62 on a bottom; and a lower positioning member 70 including two threaded holes 71 adjacent to two sides respectively, and a half-circular cavity 72 on a top. The enlargement 23 is complimentarily disposed between the opposite half-circular cavities 62, 72. The lower positioning member 70 is disposed on a lower portion of the groove A1. The upper positioning member 60 is disposed on an upper portion of the groove A1 with the shoulders 63 slidably disposed in the tunnels A2. Two set screws 80 each are driven through the threaded hole 61 into the threaded hole 71 to join the upper positioning member 60 and the lower positioning member 70.

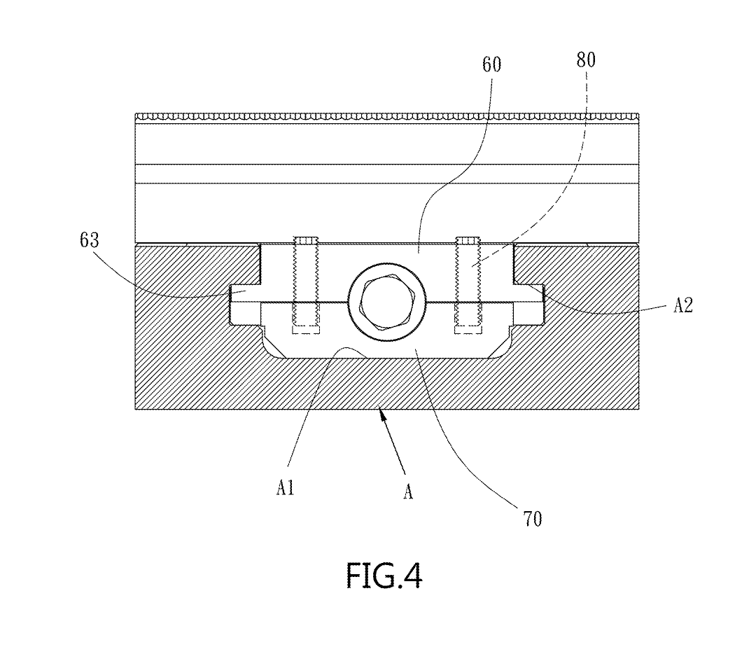

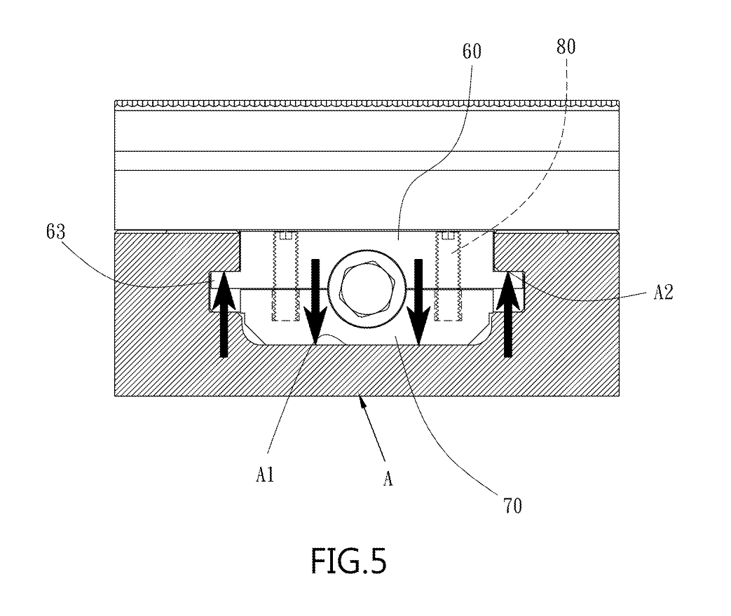

In response to a misalignment of the center of the clamping vise, an individual may use a hand tool to drive the set screws 80 counterclockwise to unfasten and adjust a tightness of the upper positioning member 60, the lower positioning member 70, and the threaded spindle 20 (see FIG. 4) or drive the set screws 80 clockwise to fasten the upper positioning member 60, the lower positioning member 70, and the threaded spindle 20 after the adjustment (see FIG. 5).

The individual may use another hand tool having a hex socket to drive the first jaw 30 or the second jaw 40 so that the first jaw 30 (or the second jaw 40) may move toward the other to hold a workpiece (not shown) in position.

While the invention has been described in terms of preferred embodiments, those skilled in the art will recognize that the invention can be practiced with modifications within the spirit and scope of the appended claims.

What is claimed is:

1. A centric clamping vise, comprising:
a base support including a longitudinal groove and two longitudinal tunnels at two sides of the longitudinal groove respectively;
a threaded spindle including an intermediate, ring-shaped enlargement, a right-handed-threaded section between the intermediate, ring-shaped enlargement and a first end, and a left-handed-threaded section between the intermediate, ring-shaped enlargement and a second end;
a first jaw moveably disposed on a first end of the longitudinal groove and including a longitudinal threaded channel with the right-handed-threaded section disposed through to expose the first end of the threaded spindle;
a second jaw moveably disposed on a second end of the longitudinal groove and including a longitudinal threaded channel with the left-handed-threaded section disposed through to expose the second end of the threaded spindle;
an upper positioning member including two shoulders at two sides respectively, two threaded holes each adjacent to the shoulder, and a half-circular cavity on a bottom;
a lower positioning member including two threaded holes adjacent to two sides respectively, and a half-circular cavity on a top; and
two set screws each driven through the threaded hole of the upper positioning member into the threaded hole of the lower positioning member to join the upper positioning member and the lower positioning member;
wherein the intermediate, ring-shaped enlargement is complimentarily disposed between the half-circular cavity of the upper positioning member and the half-circular cavity of the lower positioning member;
wherein the lower positioning member is disposed on a lower portion of the longitudinal groove; and
wherein the upper positioning member is disposed on an upper portion of the longitudinal groove with the shoulders slidably disposed in the tunnels respectively.
